(19) United States
(12) Patent Application Publication
(10) Pub. No.: US 2013/0030128 A1
(43) Pub. Date: Jan. 31, 2013

(54) THERMOPLASTIC COMPOSITION FORMED FROM POLYLACTIC ACID AND ELASTOMERIC GRAFT COPOLYMER

(71) Applicants: Chaobin He, Singapore (SG); Ting Ting Lin, Singapore (SG); Pui Kwan Wong, Singapore (SG); Suming Ye, Singapore (SG)

(72) Inventors: Chaobin He, Singapore (SG); Ting Ting Lin, Singapore (SG); Pui Kwan Wong, Singapore (SG); Suming Ye, Singapore (SG)

(73) Assignee: Agency for Science, Technology and Research, Connexis (SG)

(21) Appl. No.: 13/640,916

(22) PCT Filed: Apr. 14, 2011
(86) PCT No.: PCT/SG2011/000146

§ 371 Date: Oct. 12, 2012

Related U.S. Application Data
(60) Provisional application No. 61/324,112, filed on Apr. 14, 2010.

(51) Int. Cl. C08F 8/00; C08F 120/10

(52) U.S. Cl. 525/330.3

(57) ABSTRACT

The brittleness of a thermoplastic material containing a polylactic acid may be reduced by melting and mixing the thermoplastic material and a graft copolymer to link the graft copolymer to thermoplastic polymer to form a new thermoplastic material with reduced brittleness. The graft copolymer comprises an elastomeric backbone and a side chain grafted to the backbone. The side chain comprises a enantiomer of lactic acid opposite to the enantiomer in the thermoplastic material. A composition comprises a thermoplastic polymer and the graft copolymer, where the graft copolymer is linked to the thermoplastic polymer by the enantiomers. A method of forming the composition may comprise melting precursors for the thermoplastic polymer and the graft copolymer, and mixing the precursors to allow the lactic acids to link the graft copolymer to the thermoplastic polymer.

### CROSS-REFERENCE TO RELATED APPLICATION

This application claims the benefit of, and priority from, U.S. provisional application No. 61/324,112, filed Apr. 14, 2010, the entire contents of which are incorporated herein by reference.

### FIELD

The present invention relates generally to thermoplastic compositions, and particularly to compositions formed from polylactic acid and an elastomer, and methods of forming such thermoplastic compositions.

### BACKGROUND

Thermoplastics are widely used. Many thermoplastic polymers, such as polystyrene and poly(methyl methacrylate), are brittle (i.e. easy to break) at low temperatures, which limits their applications. Polystyrene and poly(methyl methacrylate) may be “toughened” (i.e. made able to withstand greater strain without tearing or breaking) by adding an elastomeric copolymer during the manufacturing process, so that the elastomeric copolymer chains form dispersed rubber particles in the plastic matrix formed by the thermoplastic polymer. The resulting composition is still thermoplastic but can withstand higher stress and strain without breaking, as the presence of rubber particles can increase the energy required for crack propagation by causing cavitation, crazing, or shear banding.

### SUMMARY

It is desirable to provide new and alternative thermoplastic materials with reduced brittleness. It is also desirable to provide alternative techniques to reduce brittleness of thermoplastic materials.

Accordingly, in an aspect of the present invention, there is provided a composition comprising a thermoplastic polymer comprising a first enantiomer of lactic acid, and a graft copolymer comprising an elastomeric backbone and a side chain grafted to the backbone. The side chain comprises a second enantiomer of lactic acid. The first and second enantiomers have opposite chiral configurations. The graft copolymer is selected and linked to the thermoplastic polymer by the first and second enantiomers of lactic acid so that the composition is thermoplastic and less brittle than the thermoplastic polymer.

In another aspect, there is provided a composition comprising a thermoplastic polymer comprising a first enantiomer of lactic acid, and a graft copolymer comprising an elastomeric backbone and a side chain grafted to the backbone. The side chain comprises a second enantiomer of lactic acid. The first and second enantiomers have opposite chiral configurations. The first and second enantiomers form a stereocomplex linking the thermoplastic polymer and the graft copolymer.

In certain embodiments, the thermoplastic polymer may comprise one of poly(L-lactic acid) and poly(D-lactic acid), and the side chain in the graft copolymer may comprise the other of poly(L-lactic acid) and poly(D-lactic acid). The backbone of the graft copolymer may comprise a polyacrylate, such as poly(alkyl acrylate). The poly(alkyl acrylate) may comprise n-butyl acrylate, n-hexyl acrylate, or n-octyl acrylate. The side chain may be grafted to the backbone of the graft copolymer through a hydroxy- or amine-functionalized acrylate group. The hydroxy-functionalized acrylate group may comprise hydroxyethyl acrylate, such as 2-hydroxyethyl acrylate (HEA) or 2-hydroxyethyl methacrylate. The composition may comprise about 1 to about 20 wt % of the graft copolymer. The thermoplastic polymer may have a number average molecular weight (Mn) of about 20,000 to about 500,000 g/mol, the elastomeric backbone of the graft copolymer may have an Mn of about 50,000 to about 500,000 g/mol, and the side chain of the graft copolymer may have an Mn of about 2,000 to about 50,000 g/mol. The thermoplastic polymer may comprise 100 to 5000 repeating units of the first enantiomer of lactic acid. The composition may have a percentage of elongation at break of about 23% to about 30%.

In another aspect, there is provided a method of forming the exemplary composition described herein. The method comprises melting a first precursor for the thermoplastic polymer; melting a second precursor for the graft copolymer; and mixing the first and second precursors in a mixture at a temperature above melting temperatures of the thermoplastic polymer and the graft copolymer to allow formation of stereocomplexes of lactic acid.

In certain embodiments, the method may comprise copolymerizing a monomer for the backbone and acrylate-terminated polylactic acid of the second enantiomer to form the second precursor for the graft copolymer. The second precursor for the graft copolymer may also be formed by providing a copolymer precursor for the backbone, and reacting a lactic acid with the copolymer precursor for the backbone to graft a side chain comprising an acrylate-terminated polylactic acid from the copolymer precursor for the backbone.

In a further aspect, there is provided a method of reducing brittleness of a thermoplastic material. The method comprises melting a first thermoplastic material comprising a polymer formed of a first enantiomer of lactic acid; melting a graft copolymer, the graft copolymer comprising an elastomeric backbone and a side chain grafted to the backbone, the side chain comprising a second enantiomer of lactic acid; mixing the melted first thermoplastic material with the melted graft copolymer for a sufficient time to allow the first and second enantiomers of lactic acid to react and link the polymer in the first thermoplastic material to the graft copolymer, to form a second thermoplastic material; and solidifying the second thermoplastic material to form a thermoplastic material that is less brittle than the first thermoplastic material.

In certain embodiments, the first thermoplastic material may comprise one of poly(L-lactic acid) and poly(D-lactic acid), and the side chain of the graft copolymer may comprise the other of poly(L-lactic acid) and poly(D-lactic acid). The backbone of the graft copolymer may comprise a poly(alkyl acrylate), such as poly(n-butyl acrylate).

Other aspects, features, and embodiments of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention:

FIG. 1 is a schematic diagram of a synthesis route for forming a composition exemplary of an embodiment of the present invention; and

FIG. 2 is a schematic diagram of an alternative synthesis route for forming an intermediate compound shown in FIG. 1.

### DETAILED DESCRIPTION

Certain exemplary embodiments of the present invention relate to thermoplastic compositions formed from a thermoplastic polymer and an elastomeric graft copolymer. The thermoplastic polymer includes an enantiomer of lactic acid. The graft copolymer includes a side chain having the opposite enantiomer of lactic acid. The graft copolymer is selected and linked to the thermoplastic polymer by the opposite enantiomers such that the brittleness of the thermoplastic composition is less than the brittleness of the thermoplastic polymer in its pure form.

Exemplary embodiments of the present invention also relate to thermoplastic compositions formed from a thermoplastic polymer of lactic acid and an elastomeric graft copolymer, which are linked by polylactic acid stereocomplexes (PLA stereocomplexes).

The thermoplastic polymer includes a first enantiomer of lactic acid. For example, in one embodiment, the thermoplastic polymer may be poly(L-lactic acid) (PLLA). In a different embodiment, the thermoplastic polymer may be poly(D-lactic add) (PDLA). PLLA and PDLA are also individually and collectively referred to as polylactic acid or PLA. As is known, L-lactic acid (LLA) and D-lactic acid (DLA) are enantiomers with opposite chiral configurations, and PLLA and PDLA can form a stereocomplex (PLA stereocomplex).

It should be understood that a PLA stereocomplex is different from a mere mixture of PLLA and PDLA in which no PLA stereocomplex is formed, in the sense that a PLA stereocomplex is a racemic configuration of PLLA and PDLA which exhibits properties that are significantly different from an optically pure PLA configuration. For example, the melting point temperature of a PLA material can be substantially increased due to formation of PLA stereocomplexes, as compared to the melting point temperature of a PLA material containing optically pure PLA configurations, or a mere mixture of PLLA and PDLA with no PLA stereocomplex. Thus, the formation of PLA stereocomplex in a PLA-containing material can be detected by measuring certain properties, such as melting point temperature, heat of fusion, and crystal structure (e.g. as characterized by resonance frequencies measured by a suitable spectroscopic technique) of the PLA-containing material. As can be understood, melting point temperatures may be measured by differential scanning calorimetry (DSC), heat of fusion may be measured by Dynamic Mechanical Analysis (DMA), and crystal structures may be charaterized by X-ray spectroscopy. Other suitable techniques may also be used to measure or charactorize the crystal structure in a material, as can be understood by those skilled in the art.

In a melted state or in a solution, PLLA and PDLA can self-assemble to form PLA stereocomplexes. PLA stereocomplexes can form crystalline lattices.

The graft copolymer includes an elastomeric backbone and one or more side chains grafted to the backbone. The backbone may be formed from any suitable elastomeric polymer as will be further described below. The side chain includes a second enantiomer of lactic acid. The first and second enantiomers have opposite chiral configurations. Thus, the thermoplastic polymer comprises one of PLLA and PDLA, and the side chains comprise the other of PLLA and PDLA. For example, the side chain of the graft copolymer may include PDLA when the thermoplastic polymer is PLLA; or may include PLLA when the thermoplastic polymer is PDLA.

At least some of the first and second enantiomers of polylactic acid in the composition form PLA stereocomplexes.

In some exemplary embodiments, the backbone of the graft copolymer may be formed of a polyacrylate, such as poly(alkyl acrylate). The monomer in the poly(alkyl acrylate) may include n-butyl acrylate, n-hexyl acrylate, or n-octyl acrylate. In other embodiments, the backbones of the graft copolymer may include other types of elastomeric chains. The elastomeric chain may be selected so that the graft copolymer has a transition glass temperature (T_{g}) below room temperature. The elastomeric chain may have PLA blocks or graft PLA groups.

In selected embodiments, elastomers with pendant hydroxy groups may be conveniently used to form PLA graft polymers. For example, in some embodiments, poly(isoprene) (PI) may be used as an elastomeric backbone. In different embodiments, polybutadiene or ethylene propylene diene monomer (M-class) (EPDM) rubber may be used. The double bonds in these elastomers can be functionalized, such as by hydrogenation, to saturated hydrocarbon blocks, which can be conveniently utilized to compatiblizing PLA with, e.g. polyolefins.

As can be understood, the specific elastomers to be used in a particular embodiment may be selected based on various factors of interest in the particular application, and can be determined by those skilled in the art based on known properties of different elastomeric materials, such as elasticity, mechanical strength, reactivity, solubility, chemical resistance to certain materials, compatibility with other polymers, or the like.

The side chains of the graft copolymer may be grafted to the backbone of the graft copolymer through a suitable acrylate group such as a hydroxy- or amine-functionalized acrylate group. A hydroxy- or amine-functionalized acrylate suitable for use as a ring opening polymerization initiator may be used. Suitable hydroxy-functionalized acrylates may include hydroxyethyl acrylate, such as 2-hydroxyethyl acrylate, or 2-hydroxyethyl methacrylate. In different embodiments, another suitable initiator may be used.

The initiator and the corresponding lactide or polylactide may be dissolved in a suitable organic solvent, such as anhydrous toluene or tetrahydrofuran. Various suitable Lewis acid metal complexes may be used as catalysts for the ring opening polymerization of lactide. For example, tin(II) octoate (also referred to as stannous octoate) and aluminum isopropoxide may be used. In an exemplary embodiment, the solution may contain about 1 wt % of stannous octoate based on the total weight of the lactide and the initiator. The solution may be heated to a suitable temperature, such as about 70° C., and continuously stirred. After the acrylate-terminated PLA is formed, the solvent and other components may be removed, such as by evaporation. The residue may be purified and dried according to standard procedures known to those skilled in the art.

The graft copolymer may have a relatively low glass transition temperature (T_{g}), such as below about 0° C. The elastomer in the backbone may also have a relatively high melting temperature (Tₘ). The polyacrylate may include poly(alkyl acrylate), and may be formed from an acrylate monomer such as n-butyl acrylate, n-hexyl acrylate, or n-octyl acrylate, or a combination thereof.

The graft copolymer in the composition may be about 1 to about 20 wt % based on total weight of the composition, such as from about 2 to about 10 wt %. The thermoplastic polymer (or PLA) may have a number average molecular weight (Mn) of about 20,000 to about 500,000. The number of repeating units (n) in the PLA may be from 100 to 5000. The Mn for the backbone in the graft copolymer may be from about 50,000 to about 500,000. The Mn of the side chains in the copolymer may be from about 2,000 to about 50,000. All values of Mn listed herein are given in units of g/mol.

Due to the thermoplastic chains, the composition is also thermoplastic. Due to the presence of the graft copolymer and PLA stereocomplexes, the brittleness of the composition is reduced as compared to a pure PLLA or PDLA polymer.

The brittleness of different polymers may be assessed based on the measured percentages of elongation at break in tensile tests. Tensile test is a well established technique known to those skilled in the art, and may be performed according to the ASTM D638 testing standard. In some exemplary embodiments, the percentage of elongation at break for the composition may be increased from that of pure PLLA by about 5 to about 8 times at room temperature, corresponding to a substantial reduction in brittleness. For example, an exemplary embodiment of the composition may have a percentage of elongation at break of higher than about 7%. In another exemplary embodiment, the composition may have a percentage of elongation at break of higher than about 10%. In a further exemplary embodiment, the composition may have a percentage of elongation at break of higher than about 20%. In another exemplary embodiment, the composition may have a percentage of elongation at break of about 23% to about 30%.

The composition may be prepared by melting a first precursor for the thermoplastic polymer, melting a second precursor for the graft copolymer, and mixing the melt precursors in a mixture at a temperature above the melting temperatures of the thermoplastic polymer and graft copolymer to allow formation of stereocomplexes of lactic acid.

In a specific embodiment, the elastomer may be poly(n-butyl acrylate) (PBA) formed from n-butyl acrylate (n-BA) monomers.

When PLLA is used as the precursor for the thermoplastic polymer and PBA-g-PDLA is used as precursor for the graft copolymer, the mixing temperature for mixing the blend of PLLA and PBA may be about 180° C. or higher, as the melting temperatures of PLLA and PBA-g-PDLA are typically 173-178° C. and 166-167° C., respectively.

The blend mixture of the thermoplastic polymer and graft copolymer may be stirred or otherwise agitated. The mixture may be heated and stirred for a sufficient period of time to allow formation of PLA stereocomplexes.

The graft copolymer may be produced in any suitable manner. For example, when poly(acrylate acid) (PAA) is used as the elastomeric backbone polymer, a respective PAA-g-PLA may be formed by polymerizing an alkyl acrylate with a corresponding acrylate-terminated (capped) PLA. For example the alkyl acrylate and the corresponding acrylate-terminated (capped) PLA may be dissolved in a solution that contains a suitable solvent and a suitable polymerization initiator. The solvent may be dioxane. In a different embodiment, another solvent may also be used. The initiator may be benzoyl peroxide. The solution may be bubbled with an inert gas for a period of time, such as 30 minutes, to remove air, and then heated and stirred to accelerate the desired reaction.

The acrylate-terminated PLAs may be formed by reacting a hydroxy- or amine-functionalized acrylate with L-lactide (or poly(L-lactide)), or D-lactide (or poly(D-lactide)), respectively. Hydroxy- or amine-functionalized acrylate suitable for use as a ring opening polymerization initiator may be used. Suitable hydroxy-functionalized acrylates may include hydroxyethyl acrylate, such as 2-hydroxyethyl acrylate, or 2-hydroxyethyl methacrylate. In different embodiments, another suitable initiator may be used.

The initiator and the corresponding lactide or polylactide may be dissolved in a suitable organic solvent, such as anhydrous toluene. A suitable Lewis acidic metal complexes, such as Sn(Oct)₂ (stannous octoate or stannous octanoate), may be added to the solution. For example, the solution may contain about 1 wt % of stannous octoate based on the total weight of the lactide and the initiator. The solution may be heated to a suitable temperature, such as about 70° C., and continuously stirred. After the acrylate-terminated PLA is formed, the solvent and other components may be removed, such as by evaporation. The residue may be purified and dried according to standard procedures known to those skilled in the art.

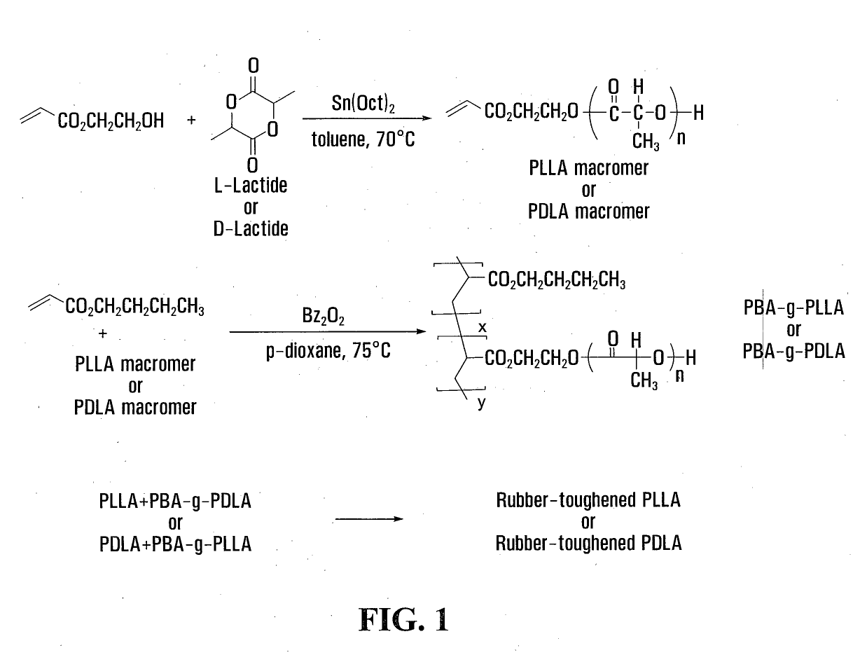

A specific exemplary synthesis route is illustrated in FIG. 1 and discussed in the Examples. In this exemplary route, PLA is grafted on the copolymer in a process known as “grafting-through”. In FIG. 1, the values of “n”, “x” and “y” may vary depending on the weight percentages, molecular weights, or ratios of the various ingredients added in the reaction process including monomers, PLA macromers, and initiators. For example, the value of “n” may be controlled by adjusting the ratio of initiator and lactide in the reaction mixture. The amount of the PLA macromer in the resulting copolymer may vary from about 10 to about 50 wt %, such as from about 20 to about 30 wt %. The molecular weight of the PLA macromer may vary from about 2,000 to about 10,000 g/mol, such as from about 5,000 to about 20,000 g/mol.

The molecular weight (such as number or weight average molecular weight) of any intermediate or product may be measured using any suitable technique. For example, the molecular weight may be determined using high pressure liquid chromatography (HPLC), gel permeation chromatography (GPC), viscometry, vapor pressure osmometry or beam scattering techniques, among others.

In selected embodiments, graft copolymers, such as PBA-g-PLLA and PBA-g-PDLA, may be prepared using a “grafting-from” polymerization technique. Briefly, a PLA graft copolymer may be formed by providing a copolymer precursor, and reacting a lactic acid with the copolymer precursor to graft a side chain comprising an acrylate-terminated polylactic acid from the copolymer precursor.

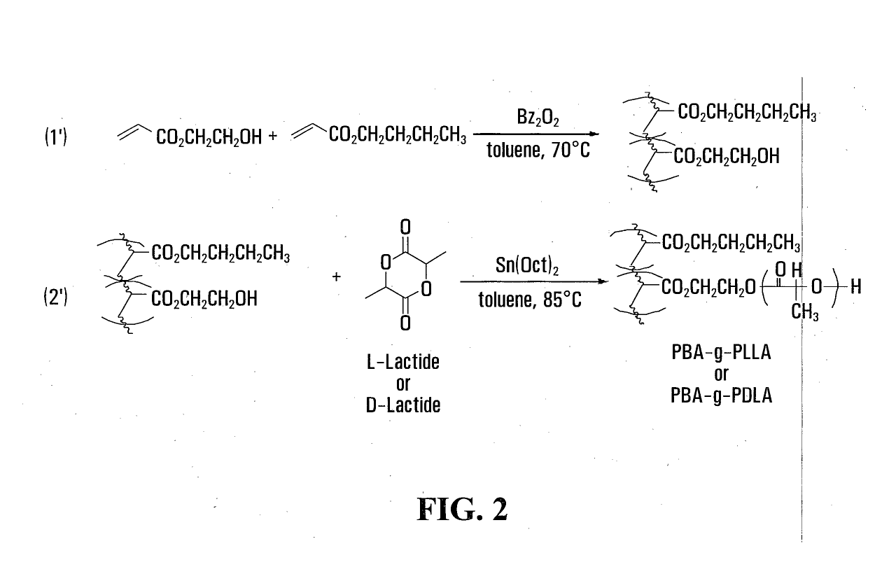

An exemplary “grafting-from” synthesis route is illustrated in FIG. 2 for grafting poly(n-butyl acrylate)-b-poly(2-hydroxyethyl acrylate) (PBA-b-PHEA) with PLA. With reference to route (1′) in FIG. 2, a copolymer precursor, PBA-b-PHEA, may be prepared by free radical polymerization using benzoyl peroxide (Bz₂O₂) as the initiator. As illustrated in route (2′) of FIG. 2, PBA-b-PHEA may be grafted with PLA by a “grafting-from” technique using hydroxylated precursors of the n-butyl acrylate polymer as a macroinitiator of the ring-opening polymerization of lactide.

A difference between the “grafting-from” technique and “grafting-through” using a PLA macromer is that with the “grafting-from” technique as illustrated in FIG. 2, more densely grafted copolymers may be obtained.

LA stereocomplexes may be formed by blending PLA enantiomers by solution casting, or by melt blending. Both solution casting and melt blending technologies are well known to those skilled the art and can be readily adapted for application in the exemplary embodiments herein.

For example, melt blending may be conducted for example at 180° C. for about 10 minutes. The melt blend may be a 50:50 blend. That is the polymer containing PLLA and the polymer containing PDLA in the blend may have a 1:1 weight ratio. The melt blend may be dried and compression molded at, for example, about 200° C. Conveniently, the dried blend may have a melting temperature as high as about 220° C., and a transition glass temperature of about −26° C.

The exemplary embodiments disclosed herein may be conveniently used in many applications of different fields. For example, exemplary compositions disclosed herein may be used as thermoplastics or rubber replacements.

Rubbers or other thermoplastic materials may be toughened according to exemplary embodiments disclosed herein.

For example, to reduce brittleness of a thermoplastic material that includes a polymer formed of a first enantiomer of lactic acid, the thermoplastic material may be melted and mixed with a melted graft copolymer described herein in which a side chain grafted to the backbone of the graft copolymer includes a second enantiomer of lactic acid, with a chiral configuration opposite to that of the first enantiomer. The melted initial thermoplastic material and graft copolymer may be mixed for a sufficient time to allow the first and second enantiomers of lactic acid to form stereocomplexes, thus linking the polymer in the initial thermoplastic material, to the graft copolymer, to form a resulting thermoplastic material. Conveniently, after the resulting thermoplastic material is solidified, it is less brittle than the initial thermoplastic material.

It will be understood that when references are made to polymers formed of a specific monomer, such as L-lactic acid or D-lactic acid, the polymers are not necessarily entirely formed of the specified monomer. For example, a PLLA may not be formed of 100% LLA monomer units and a PDLA may not be formed of 100% DLA monomer units. In practice, a 100% pure polymer form is difficult to obtain, and the polymers may contain other components such as other monomers and defects. For example, a PLLA polymer may contain a small percentage of DLA or PDLA, and a PDLA polymer may contain a small percentage of LLA or PLLA. Depending on the particular application, in some embodiments, the purity of the polymer, including the optical purity of the polymer, may be from about 90% to about 100%. In some embodiments, the purity of the polymer may be from about 95% to about 100%. In some embodiments, the purity of the polymer may be from about 85% to about 100%. In some embodiments, the optical purity of the polymer may be above 66%, or above 72%. In some embodiments, the mole fraction of the minor enantiomer in the polymer may be less than 0.14, or less than 0.17.

Exemplary embodiments of the present invention are further illustrated with the following examples, which are not intended to be limiting.

### EXAMPLES

Lactide used in these examples was purchased from Purac Biomaterials™, and was used as received, unless otherwise specified. The synthesis route for preparing the intermediate and final sample materials is as shown in FIG. 1.

Instron™ 5569 table universal testing machine was used to measure stress/strain of the samples according to ASTM D638.

### Example I

### Synthesis of PLLA Macromers

Sample PLLA macromers were prepared following the synthesis route (1) shown in FIG. 1. For each sample, a selected amount of L-lactide and stannous octoate (1 wt % of the total weight of lactide and the initiator) were dissolved in 150 ml anhydrous toluene in a Schlenk flask under an argon atmosphere. A selected amount of 2-hydroxyethyl acrylate was added to the solution as the ring opening initiator. The amounts of the initiator and the catalyst were adjusted to form different samples with different molecular weights. The resulting mixture was heated to 70° C. and stirred for 3 days. Toluene was then removed under reduced pressure using a rotary evaporator. The residue was purified by dissolution in CH₂Cl₂ and precipitation from the solution by addition of methanol. The precipitate was dried under vacuum at 55-60° C. for 24 hours.

For one of the samples, referred to as Sample I, 21.6 g (150 mmol) of L-lactide, 0.221 g of stannous octoate, and 513.3 mg (4.42 mmol) of 2-hydroxyethyl acrylate were used to produce about 21.3 g of PLLA macromer, with GPC Mn=8094 and Mw=9967.

Two other samples, referred to as Sample IA and Sample IB, were formed with 14.4 g L-lactide and different amounts of initiator and catalyst. Molecular weights were found to be Mn=14319 and Mw=15356 for Sample IA, and Mn=28468 and Mw=32023 for Sample IB.

### Example II

### Synthesis of PDLA Macromers

The procedure shown in route (1) of FIG. 1 and as described in Example I was followed but the L-lactide was replaced with D-lactide to produce PDLA macromer samples.

For Sample II, 21.6 g (150 mmol) of D-lactide, 0.221 g of stannous octoate, and 513.3 mg (4.42 mmol) of 2-hydroxyethyl acrylate were used to produce about 21.3 g of PDLA macromer, with GPC Mₙ=8308 and M_{w}=9976.

For Samples IIA and IIB, 14.4 g of D-lactide was used and the amounts of the initiator and catalyst were adjusted to produce sample macromers with different molecular weights. Sample IIA: Mn=13400 and Mw=14316. Sample IIB: Mn=28424 and Mw=31943.

### Example III

### Synthesis of Graft Copolymer PBA-g-PLLA

PBA-g-PLLA samples were prepared following the synthesis route (2) shown in FIG. 1. 9 g of n-Butyl acrylate (n-BA), 3 g of PLLA of Sample I, and 120 mg (1 wt %) of benzoyl peroxide were dissolved in 25 ml dioxane in a 100 ml Schlenk flask. The resulting solution was bubbled with argon for about 30 min to remove air and then heated to 70° C. with stirring overnight. The hot solution was poured into methanol to precipitate the graft copolymer. The precipitate yielded 10.7 g of graft copolymer PBA-g-PLLA (Sample III), with GPC Mₙ=67208 and M_{w}=239745.

Samples IIIA and IIIB were also prepared following the above procedure, but with Samples IA and IB as the respective PLLA macromer. Sample IIIA: Mn=61182 and Mw=167207. Sample IIIB: Mn=100348 and Mw=287192.

Sample IIIC was prepared as follows. 5 g of n-Butyl acrylate (n-BA), 3.3 g of PLLA of Sample IB, and 83 mg (1 wt %) of benzoyl peroxide were dissolved in 15 ml dioxane in a 100 ml Schlenk flask. The resulting solution was bubbled with argon for about 30 min to remove air and then heated to 75° C. with stirring overnight. The hot solution was poured into methanol to precipitate the graft copolymer. The precipitate yielded 6.8 g of graft copolymer PBA-g-PLLA (Sample IIIC), with GPC Mₙ=98637 and M_{w}=277134.

### Example IV

### Synthesis of Graft Copolymer PBA-g-PDLA

PBA-g-PDLA samples were prepared according to the synthesis route (2) of FIG. 1. 9 g of n-Butyl acrylate, 3 g of PDLA of Sample II, and 120 mg (1 wt %) of benzoyl peroxide were dissolved in 20 ml dioxane in a 100 ml Schlenk flask. The resulting solution was bubbled with argon for about 30 min to remove air and then heated to 70° C. with stirring overnight. The hot solution was poured into methanol to precipitate the graft copolymer. The precipitate yielded 10.6 g of graft copolymer PBA-g-PDLA (Sample IV), with GPC=68747 and M_{w}=274797.

Samples IVA and IVB were also prepared following the above procedure. However, the macromers used were Sample IIA or IIB, respectively, instead of Sample II. Sample IVA: Mn=72731 and Mw=240989. Sample IVB: Mn=92390 and Mw=303983.

Sample IVC was prepared as follows. 5 g of n-Butyl acrylate 3.3 g of PDLA of Sample IIB, and 83 mg (1 wt %) of benzoyl peroxide were dissolved in 15 ml dioxane in a 100 ml Schlenk flask. The resulting solution was bubbled with argon for about 30 min to remove air and then heated to 75° C. with stirring overnight. The hot solution was poured into methanol to precipitate the graft copolymer. The precipitate yielded 7.0 g of graft copolymer PBA-g-PDLA (Sample IVC), with GPC Mₙ=93511 and M_{w}=271863.

### Example V

### Blend of PLLA and PBA-g-PDLA

For preparing each sample blend, PLLA (obtained from NatureWorks™, 3051D) and 10 wt % of Sample IVA or Sample IVB were mixed in a Brabender™ mixer for 15 min at 180° C. and 50 rpm to produce the blend. The blend was removed from the mixer and cooled to room temperature, and then grounded into smaller particles in a grinder. Samples VA and VB (also collectively referred to as Samples V) were prepared with Sample IVA or Sample IVB respectively.

### Example VI

### Blend of PLLA and PBA-g-PLLA (Comparison Samples)

Samples VIA and VIB (also collectively referred to as Samples VI) were prepared according to the procedures described in Example V, but replacing Sample IVA or IVB with Sample IIIA or IIIB, respectively.

### Example VII

### Stress-Strain Measurements

Young's modulus, tensile strength and tensile strain at break point of the shaped samples prepared in Example VI were measured using an Instron™ 5569 table universal testing machine at a crosshead speed of 1 mm/min, according to ASTM D638 standard.

To prepare the test specimens, the respective sample powders were dried under vacuum, placed in a steel mold (100 mm×100 mm, sample holding area), and pressed using a Carver™ hydraulic press at 195° C. for 5 min. The press plates and the mold were cooled to room temperature before the press plates were removed from the mold. Dumbbell-shaped specimens of Samples V were punched with a hollow die (die type: ASTM D638 type V) from hot compression-molded plates. For tensile tests, tensile bars of the samples were die-cut from sample materials in plate form.

Shaped PLLA (NatureWorks™, 3051D) samples, Samples V, and Samples VI were subjected to stress-strain tests at room temperature respectively. Representative measured results are summarized in Table I. The values of “Strain at break” in Table I reflect the tensile strain on a given sample when it broke under stress. The tensile strain is a measure of change in length of the sample at point of break, and can be expressed in elongation (e) as, e=(L−L₀)/L₀, where L₀ and L are the initial sample length and the sample length under a given stress, respectively.

As can be seen in Table I, as compared to PLLA, negligible changes were produced by adding PBA-g-PLLA graft copolymer (Samples VI), but significant changes were shown in Samples V which included blends of PLLA and PBA-g-PDLA. The measured percentages of elongation at break for Samples V were significantly higher than those of PLLA Samples and Samples VI. That is, the brittleness of Samples V was significantly less than that of PLLA samples and Samples VI. This result demonstrates that PLA stereocomplex formation at the interface between PLA polymer and the elastomeric graft copolymer can provide sufficient interfacial adhesion for toughening thermoplastic PLA materials.

TABLE I
Results of Stress-strain test

| | Mₙ | | Young's | Tensile | Strain at |
|---|---|---|---|---|---|
| | graft | | Modulus | Strength | Break |
| Sample | copolymer | PLA | (GPa) | (MPa) | (%) |
| PLLA | | 79462 | 3.2 ± 0.2 | 49.4 ± 4.6 | 4.2 ± 1.3 |
| (control) | | | | | |
| VIA | 61,182 | 14,319 | 3.2 ± 0.5 | 37.2 ± 2.5 | 6.2 ± 2.9 |
| VIB | 100,348 | 28,468 | 3.2 ± 0.2 | 30.5 ± 0.8 | 7.0 ± 3.1 |
| VA | 72,731 | 13,400 | 2.5 ± 0.2 | 25.2 ± 0.9 | 23.3 ± 12.1 |
| VB | 92,390 | 28,424 | 2.7 ± 0.1 | 25.9 ± 1.1 | 29.7 ± 13.2 |

### Example VIII

### Synthesis of Graft Copolymers by Alternative Routes

Sample graft copolymers PBA-g-PLA were also prepared following the synthesis route shown in FIG. 2. In particular, poly(n-butyl acrylate)-b-poly(2-hydroxyethyl acrylate) (PBA-b-PHEA) grafted with PLA was prepared.

With reference to route (1′) in FIG. 2, PBA-b-PHEA was prepared by free radical polymerization using benzoyl peroxide (Bz₂O₂) as the initiator. It was then grafted with PLA by a “grafting from” technique using hydroxylated precursors of the n-butyl acrylate (n-BA) polymer as a macroinitiator of the ring-opening polymerization of lactide as shown in route (2′) of FIG. 2.

In this example, 54 g (0.42 mol) n-BA, 0.58 g HEA (0.005 mol) (feed molar ratio of n-BA to HEA was 84) and 183 mg Bz₂O₂ were dissolved in 75 ml dry toluene and then degassed via three freeze-thaw cycles. The mixture was stirred at 70° C. overnight. The viscous mixture was then diluted with THF and poured into large excess of methanol. The solution stood still for a few hours and the upper layer was decanted. To remove methanol and moisture, the obtained PBA-b-PHEA was dissolved in toluene and the solvent was removed on a rotovap. It was further dried in vacuum oven at 70° C. until no water peak was seen from nuclear magnetic resonance (NMR). 43.38 g of PBA-b-PHEA, denoted as Sample VIII-1, was obtained, with Mn=90620 and Mw=194037.

In a 3-neck flask, 43.38 g of Sample VIII-1, 28.92 g LLA (feed weight ratio of n-BA to LLA is 1.5) were dissolved in 200 ml dry toluene and then 0.29 g Sn(Oct)₂ in 5 ml toluene was added via syringe. The mixture was stirred under Ar by a mechanical stirrer at 85° C. for 3 days. Toluene was then removed from the rotovap. The residue was purified by dissolution in CH₂Cl₂ and precipitation from the solution by addition of methanol. The precipitate was dried under vacuum at 55-60° C. for 24 hours. The resulting sample was denoted as Sample VIII-L.

Samples VIII-2 and VIII-D were also prepared, following the above procedures for forming. Samples VIII-1 and VIII-L respectively, with the exception that, instead of L-lactide, D-lactide was used for forming Samples VIII-2 and VIII-D. For Sample VIII-2, Mn=92246 and Mw=274840.

Some test results of the samples are shown in Table II, in which the values of the weight ratio of W_{pn-BA}/W_{PLA} were obtained from NMR.

TABLE II
Composition and Molecular Weight of
Graft Copolymers VIII-L and VIII-D

| Sample | Mn | Mw | W_{pn-BA}/W_{PLA} |
|---|---|---|---|
| VIII-L | 111825 | 208087 | 1.63 |
| VIII-D | 143023 | 274840 | 1.47 |

As now can be understood, thermoplastic PLA polymers can be conveniently toughened in a relatively simple process by blending melts of PLA of one enantiomer and a graft copolymer of an elastomer and a PLA of the opposite enantiomer. It is expected that PLA stereocomplexes formed in the resulting composition can link the thermoplastic chains to the elastomeric chains, thus reducing the brittleness of the resulting composition as compared to a pure PLA polymer.

It will be understood that any range of values herein is intended to specifically include any intermediate value or sub-range within the given range, and all such intermediate values and sub-ranges are individually and specifically disclosed.

It will also be understood that the word “a” or “an” is intended to mean “one or more” or “at least one”, and any singular form is intended to include plurals herein.

It will be further understood that the term “comprise”, including any variation thereof, is intended to be open-ended and means “include, but not limited to,” unless otherwise specifically indicated to the contrary.

When a list of items is given herein with an “or” before the last item, any one of the listed items or any suitable combination of two or more of the listed items may be selected and used.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

1. A composition, comprising:
a thermoplastic polymer comprising a first enantiomer of lactic acid;
a graft copolymer comprising an elastomeric backbone and a side chain grafted to said backbone, said side chain comprising a second enantiomer of lactic acid, said first and second enantiomers having opposite chiral configurations,
wherein said backbone of said graft copolymer comprises a polyacrylate,
wherein said graft copolymer is selected and linked to said thermoplastic polymer by said first and second enantiomers of lactic acid so that said composition is thermoplastic and less brittle than said thermoplastic polymer.

2. A composition, comprising:
a thermoplastic polymer comprising a first enantiomer of lactic acid,
a graft copolymer comprising an elastomeric backbone and a side chain grafted to said backbone, said side chain comprising a second enantiomer of lactic acid, said first and second enantiomers having opposite chiral configurations,
wherein said backbone of said graft copolymer comprises a polyacrylate;
wherein said first and second enantiomers form a stereocomplex linking said thermoplastic polymer and said graft copolymer.

3. A composition consisting essentially of:
a thermoplastic polymer comprising a first enantiomer of lactic acid,
a graft copolymer comprising an elastomeric backbone and a side chain grafted to said backbone, said side chain comprising a second enantiomer of lactic acid, said first and second enantiomers having opposite chiral configurations;
wherein said first and second enantiomers form a stereocomplex linking said thermoplastic polymer and said graft copolymer.

4. The composition of claim 1, wherein said side chain is grafted to said backbone of said graft copolymer through a hydroxy-functionalized acrylate group.

5. The composition of claim 1, comprising about 1 to about 20 wt % of said graft copolymer.

6. The composition of claim 1, wherein said thermoplastic polymer has a number average molecular weight (Mn) of about 20,000 to about 500,000 g/mol, said elastomeric backbone of said graft copolymer has an Mn of about 50,000 to about 500,000 g/mol, and said side chain of said graft copolymer has an Mn of about 2,000 to about 50,000 g/mol.

7. The composition of claim 1, wherein said thermoplastic polymer comprises 100 to 5000 repeating units of said first enantiomer of lactic acid.

8. The composition of claim 1, having a percentage of elongation at break of about 23% to about 30%.

9. A method of forming the composition of claim 1, comprising:
melting a first precursor for the thermoplastic polymer;
melting a second precursor for the graft copolymer;
mixing said first and second precursors in a mixture at a temperature above melting temperatures of the thermoplastic polymer and the graft copolymer to link said thermoplastic polymer and said graft copolymer by the first and second enantiomers of lactic acid.

10. The method of claim 9, wherein said mixture is heated to about 180° C.

11. The method of claim 9, comprising copolymerizing a monomer for said backbone and acrylate-terminated polylactic acid of said second enantiomer to form said second precursor.

12. The method of claim 9, comprising providing a copolymer precursor for said backbone, and reacting a lactic acid with said copolymer precursor for said backbone to graft a side chain comprising an acrylate-terminated polylactic acid from said copolymer precursor for said backbone, thus forming said second precursor for said graft copolymer.

13. A method of reducing brittleness of a thermoplastic material, said method comprising:
melting a first thermoplastic material comprising a polymer formed of a first enantiomer of lactic acid;
melting a graft copolymer, said graft copolymer comprising an elastomeric backbone and a side chain grafted to said backbone, said side chain comprising a second enantiomer of lactic acid,
wherein said backbone of said graft copolymer comprises a polyacrylate;
mixing said melted first thermoplastic material with said melted graft copolymer for a sufficient time to allow said first and second enantiomers of lactic acid to react and link said polymer in said first thermoplastic material to said graft copolymer, to form a second thermoplastic material; and
solidifying said second thermoplastic material to form a thermoplastic material that is less brittle than said first thermoplastic material.

14. A composition consisting essentially of:
a thermoplastic polymer comprising a first enantiomer of lactic acid;
a graft copolymer comprising an elastomeric backbone and a side chain grafted to said backbone, said side chain comprising a second enantiomer of lactic acid, said first and second enantiomers having opposite chiral configurations,
wherein said graft copolymer is selected and linked to said thermoplastic polymer by said first and second enantiomers of lactic acid so that said composition is thermoplastic and less brittle than said thermoplastic polymer.
